(19) United States
(12) Patent Application Publication
(10) Pub. No.: US 2008/0219760 A1
(43) Pub. Date: Sep. 11, 2008

(54) Fixing base for bike auxiliary handle bar

(75) Inventors: Yi-Fen Wu, DajiaTownship (TW); I-Shuo Chao, Dadu Township (TW)

Correspondence Address: TROXELL LAW OFFICE PLLC, SUITE 1404, 5205 LEESBURG PIKE, FALLS CHURCH, VA, 22041, US

(73) Assignee: SHIENY CO., LTD.

(21) Appl. No.: 11/716,028

(22) Filed: Mar. 9, 2007

(51) Int. Cl. F16B 2/18

(52) U.S. Cl. 403/322.4

(57) ABSTRACT

A fixing base for bike auxiliary handle bar includes and upper portion having its upper end incorporated to a protection pad holder and a lower portion having its lower end incorporated to an auxiliary handle bar; an arc groove being each disposed on the lower end of the upper portion and on the upper end of the lower portion for both upper and lower portions to be inserted to each other; both fronts of the upper and the lower portions being movably pivoted to each other; a locating seat provided with a central locating hole being disposed to a terminal of the upper portion; a retainer being inserted into the locating hole; a locating block with its top disposed with an arc groove being inserted into the retainer, an open trough being disposed to a terminal of the locating seat; an insertion seat being disposed to a terminal of the lower portion; an open trough being disposed to a terminal of the insertion seat, a through hole connecting to the open trough being axially provided in the insertion seat to receive a pivoting pin provided with a central through hole to pivot an adjusting bolt to a biased hole disposed on the inner side of the pad holder; the adjusting bolt passing through the locating block, the retainer, the pivoting pin, and engaging an adjusting nut for the adjusting bolt to execute tightening up or loosing up through the biased hole by turning the pad holder so to achieve summary operation to mount or separate the fixing base and the pad holder onto or from the handle bar.

### BACKGROUND OF THE INVENTION

(a) Field of the Invention

The present invention is related to a fixing base for a bike auxiliary handle bar associated with rest protection pad disposed at the central front of a handle bar of the bike, and more particularly, to one that allows easier adaptation of the holder of the rest protection pad to the handle bar of the bike.

(b) Description of the Prior Art

As illustrated in FIGS. 1, 2, and 3 of the accompany drawings, a bike auxiliary handle bar fixing base 2 of the prior art is comprised of an upper portion 21 having its upper end incorporated with a pad holder 31 of a rest protection pad 3, and a lower fixing base 31 having its lower end incorporated to an auxiliary handle bar 4. Wherein, an arc groove 211 is disposed at the bottom of the upper portion 21; an erected connection hole 212 is disposed at the rear end of the upper portion 21 and connected to a linkage 214 by means of an insertion pin 214; multiple adjusting holes 215 are disposed on the linkage 214; and multiple bolts 216 pass through those adjusting holes 215 and multiple through holes 311 disposed on the pad holder 31 to secure the linkage 214 to the pad holder 31. An arc groove 221 is disposed on the upper end of the lower portion 22, one erected connection hole 222 is each provided on the front and the rear of the arc groove 221 and a circular holder 223 is disposed on the lower end of the arc groove 221; a through hole 224 facing front is disposed in the circular holder 223 for a terminal of an auxiliary handle bar 4 to pass through; a cut 225 is disposed externally to the through hole 224; an erected connection hole 226 is provided at the bottom of the cut 225; and a bolt 227 passes through the connection hole 226 to secure the auxiliary handle bar to the lower end of the lower portion 22.

To incorporate the pad holder 31 of the rest protection pad 3 to a handle bar 5 of the bike, the upper portion 21 of the fixing base 2 above the mid section of the handle bar 5 and the lower portion 22 of the handle bar 5 below the handle bar 5 must be aligned to each other; both connection holes 212 respectively disposed at the front and the rear of the upper portion 21 and both connection holes 222 respectively disposed at the front and the rear of the lower portion 22 must be aligned to each other; the arc groove 211 at the bottom of the upper portion 21 of the fixing base 2, and the handle bar 5 is inserted into a circular hole defined by the arc groove 221 disposed at the top of the lower portion 22 of the fixing base 2 and the arc groove 211 as illustrated in FIG. 3. Each of a pair of bolts 23 respectively penetrating through the connection hole 212 and the connection hole 222 to secure both of the upper portion 21 and the lower portion 22 of the fixing base 2 to the mid section of the handle bar 5 as illustrated in FIG. 2. Then each of another pair of bolts 216 penetrates through the through hole 311 disposed on the pad holder 31 to secure the pad holder 31 to the adjusting hole 215 disposed on the linkage 214. Accordingly, whereas the linkage 214 is connected to the top of the upper portion 21 by means of the pin 213, the pad holder 31 of the rest protection pad 3 is integrated with the upper portion 21 of the fixing base 2.

However, to incorporate both of the upper holder 21 and the lower holder 22 of the fixing base 2 to the handle bar 5, both connection holes 212 respectively disposed at the front and the rear of the upper portion 21 and both connection holes 222 respectively disposed at the front and the rear of the lower portion 22 must be aligned to each other. To achieve this, a hand tool (not illustrated) must be used to mount both connection bolts 23 to their respective connection holes 212 and 222 before securing both of the upper and the lower holders 21 and 22 to the mid section of the handle bar 5; meanwhile, the pad holder 31 of the rest protection pad 3 is also secured to the mid section of the handle bar 5. On the contrary to remove the rest protection pad 3 from the handle bar 5, the same tool is needed to dismount both connection bolts 23. Accordingly, it becomes inconvenient that a hand tool is needed to tighten up or loosen up the connection bolts 23 for mounting or dismounting the upper and the lower portions 21 and 22 of the fixing base 2 to or from the handle bar 5; and since either or both connection bolts 23 when removed could be easily lost, new connection bolts 23 may not be readily available.

### SUMMARY OF THE INVENTION

The primary purpose of the present invention is to provide a fixing base for a bike auxiliary handle bar to correct the flaws found with the prior art. To achieve the purpose, the present invention is comprised of a fixing base including an upper portion and a lower portion. The upper portion has its upper end incorporated to a protection pad; and the lower end of the lower portion has its lower end incorporated to an auxiliary handle bar. Two arc grooves are respectively disposed on the lower end of the upper portion and the upper end of the lower portion for both of the upper and the lower portions to be inserted to each other. Both of the front ends of the upper and the lower portions are movably pivoted to each other. A locating seat disposed at its center a locating hole extends from a terminal of the upper portion of the fixing base to be inserted with a retainer and a locating block with an arc top is inserted into the retainer. An open trough is disposed at a terminal of the locating seat. An insertion seat extends from a terminal of the lower portion of the fixing base. An open trough is disposed at a terminal of the insertion seat, and a through hole is axially disposed to the insertion seat to receive insertion of a pivoting pin, and a through hole is disposed through the center of the pivoting pin to connect through the open trough of the insertion seat. A biased hole is disposed on the inner side of the protection pad holder for a regulating bolt to pivot to the protection pad holder through the biased hole. The lower end of the adjusting bolt passes through the locating block, the retainer, the pivoting pin, and is finally engaged to an adjusting nut. Accordingly, by turning the protection pad holder for the biased hole to cause the adjusting bolt to execute the operation of tightening up or loosening up thus to incorporate or separate the upper and the lower portions of the fixing base to or from the handle bar for achieving a summary manipulation.

### BRIEF DESCRIPTION OF THE DRAWINGS

FIG. 1 is an exploded view of a construction of the prior art.

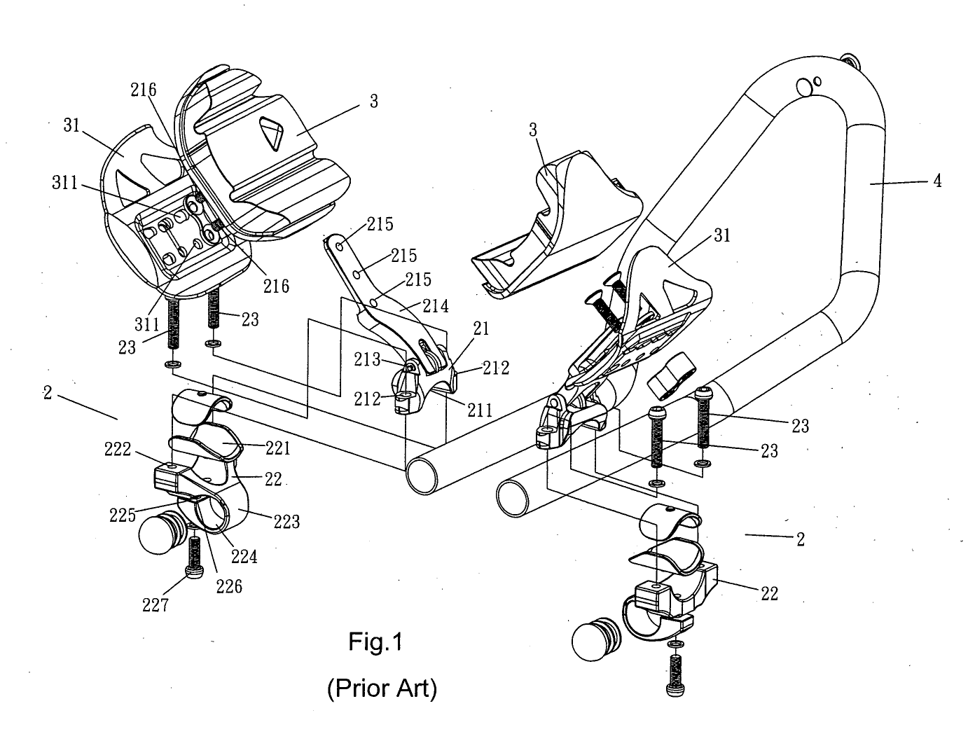

FIG. 2 is a schematic view showing the prior art as assembled.

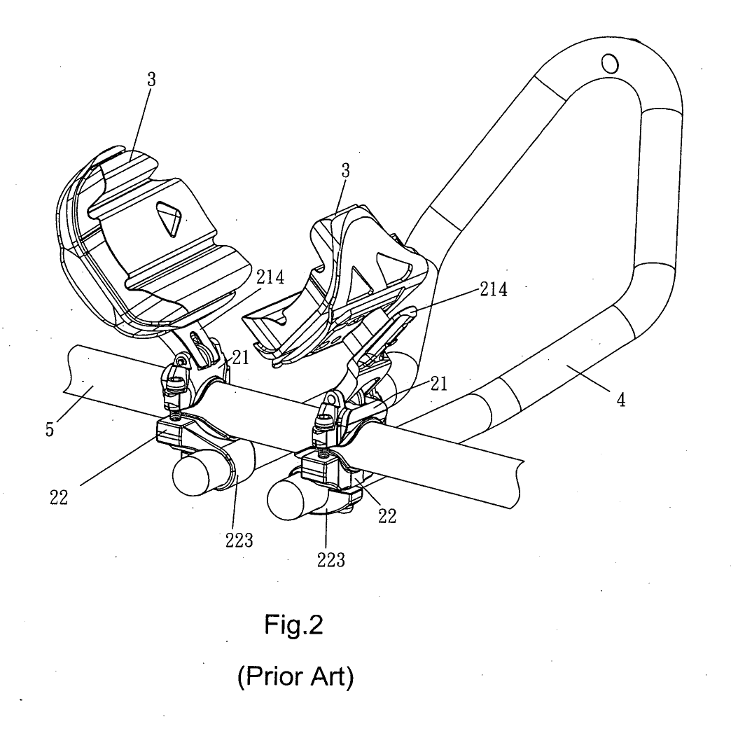

FIG. 3 is a side view of the prior art.

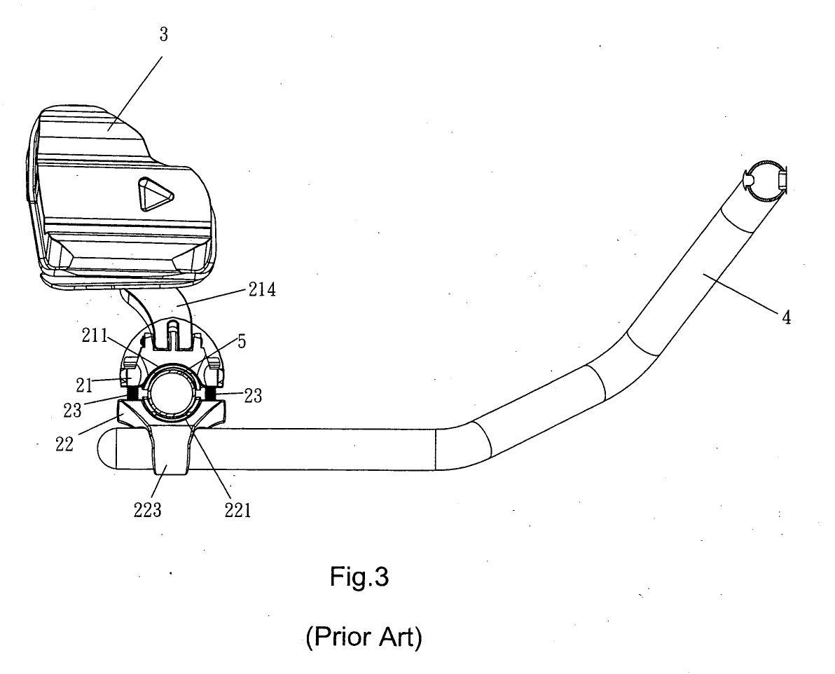

FIG. 4 is an exploded view of a construction of the present invention.

FIG. 5 is a schematic view showing the present invention as assembled.

FIG. 6 is a schematic view showing the present invention is mounted to handle bars of a bike.

FIG. 7 is a sectional view of the present invention.

FIG. 8 is a sectional view showing an operating status of the present invention.

FIG. 9 is a sectional view showing another operating status of the present invention.

FIG. 10 is an exploded view showing another preferred embodiment of the present invention.

FIG. 11 is a schematic view showing another preferred embodiment of the present invention as assembled.

FIG. 12 is a schematic view showing another preferred embodiment of the present is adapted to a protection pad holder.

### DETAILED DESCRIPTION OF THE PREFERRED EMBODIMENTS

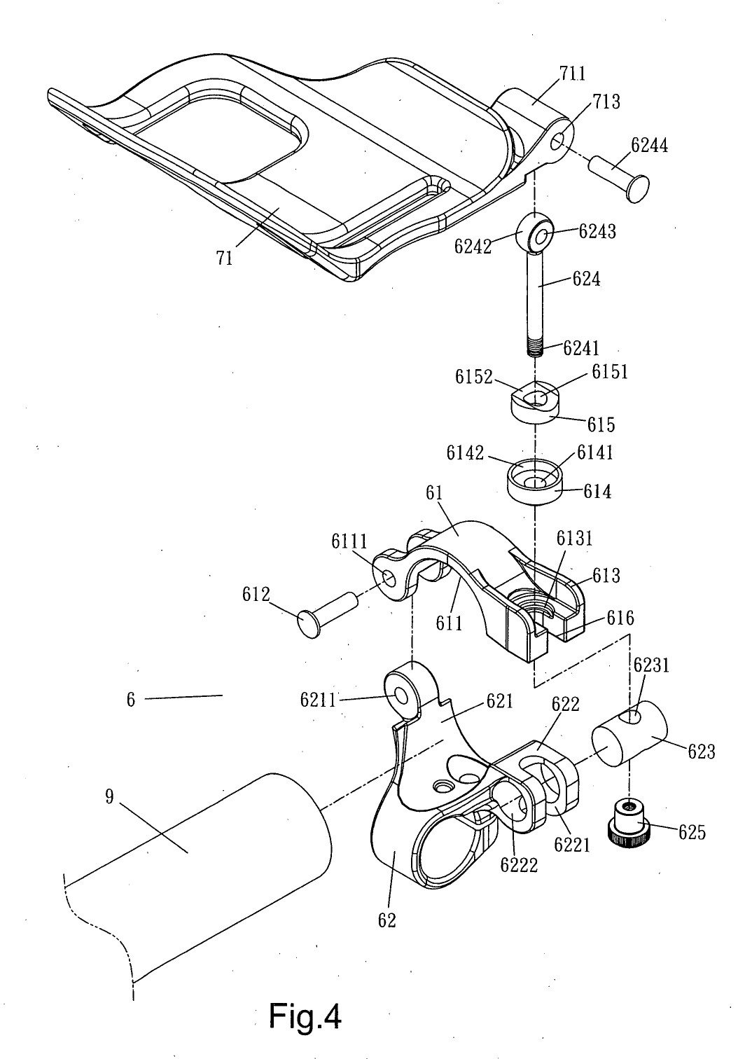

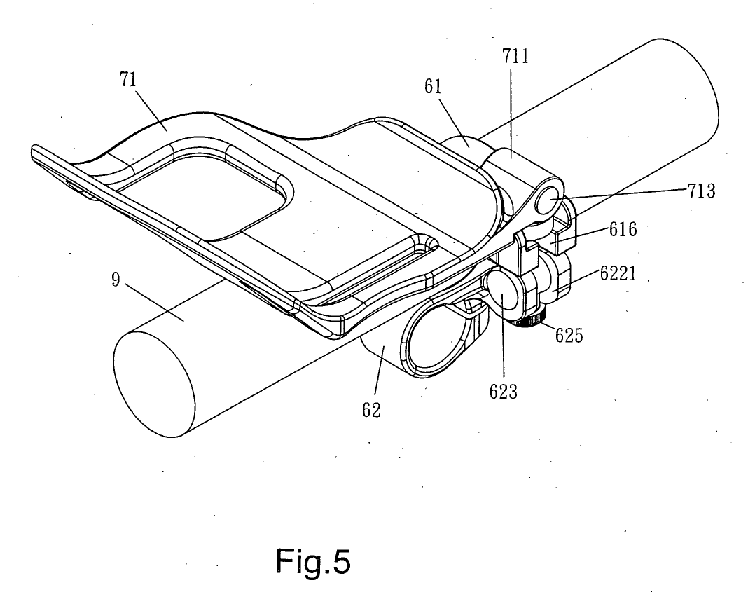

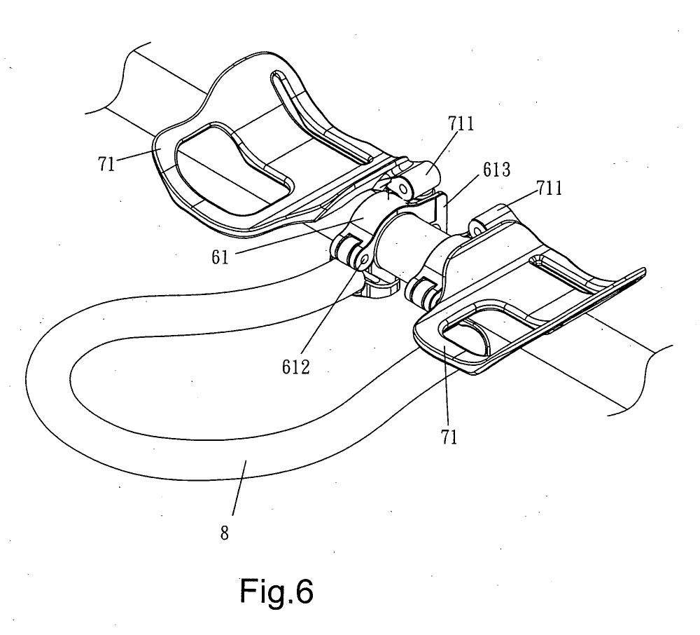

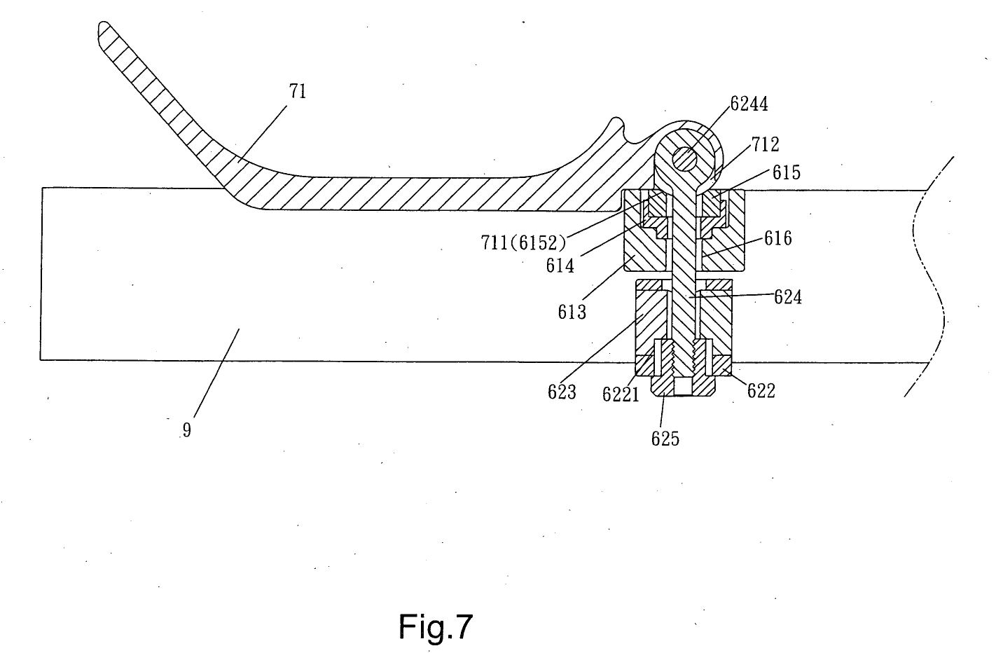

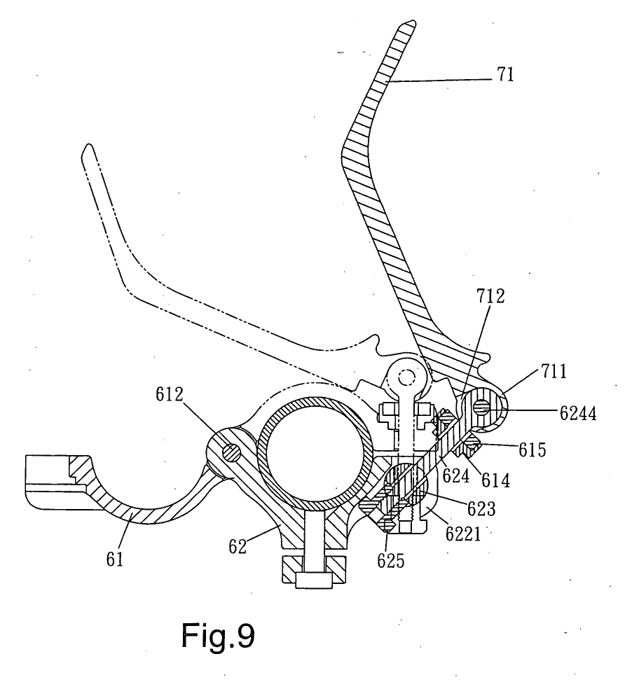

Referring to FIGS. 4 through 9, a fixing base 6 of the present invention for bike auxiliary handle bar is essentially comprised of an upper portion 61 having its upper end incorporated to a holder 71 of a rest protection pad 7 and a lower portion 62 having its lower end incorporated to an auxiliary handle bar 8. Wherein, an arc groove 611 is disposed on the bottom of the upper portion 61 of the upper portion 61, and another arc groove 621 is disposed on the upper end of the lower portion 62 of the fixing base 6. Both of the upper portion 61 and the lower portion 62 are inserted to each other. An inner side 711 of the pad holder 71 is directly made in a cylindrical form; an accommodation trough 712 is disposed at the bottom in the inner side 711; and a biased hole 713 connecting through the accommodation trough 712 is axially disposed in the inner side 711. A front each of the upper portion 61 and the lower portion 62 of the fixing base 6 is disposed with a pivoting hole 6111, 6211 to receive insertion of a pin 612 to achieve movably connection between the fronts of the upper and the lower portions 61, 62 of the fixing base 6. A locating seat 613 having at its center provided with a locating hole 6131 is disposed at a terminal of the upper portion 61 of the fixing base 6. The locating seat 613 is inserted with a retainer 614 having at its center disposed with a through hole 6141. An accommodation trough 6142 is upwardly disposed in the retainer 614 to receive a locating block 615. The locating block 6151 is disposed at its center a through hole 6151 and on its top an arc trough 6152. An open trough 616 connecting through the locating hole 6131 is disposed at a terminal of the locating seat 613. An insertion seat 622 is disposed at a terminal of the lower portion 62 of the fixing base 6; an open trough 6221 is disposed at a terminal of the insertion seat 622, and a through hole 6222 connecting through the open trough 6221 is axially disposed to the insertion seat 622 to receiver insertion of a pivoting pin 623 having at its center disposed with a through hole 6231. An adjusting bolt 624 having a threaded lower end 6151 passes through the central hole 6151 of the locating block 615, the central hole 6141 of the retainer 614, the central hole 6231 of the pivoting pin 623, and is finally engaged to an adjusting nut 625. A through hole 6243 is disposed on the top of the adjusting bolt 624, and the top of the adjusting bolt 624 is received in the accommodation trough 712 at the bottom in the inner side 711 of the protection pad holder 71, and is then pivoted to the protection pad holder 71 by means of a pin 6244.

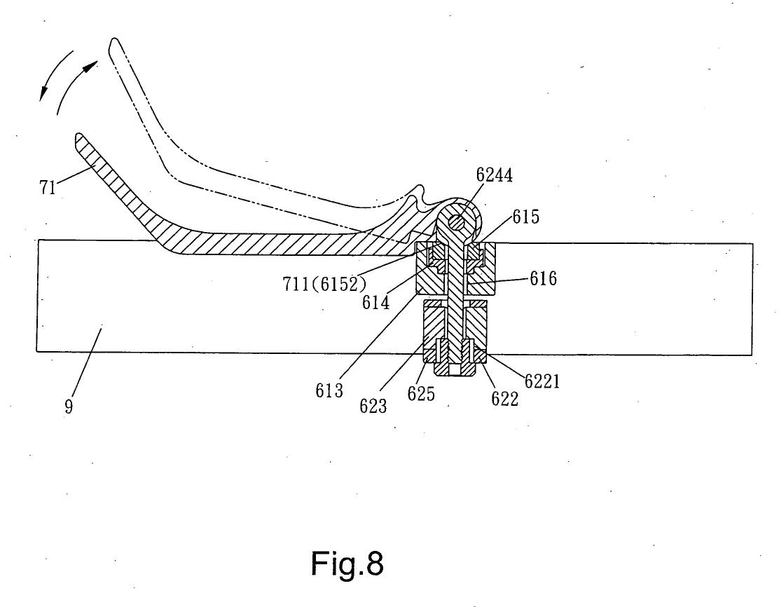

Accordingly, to connect the pad holder 71 to a bike handle bar 9 by means of the fixing base 6, both fronts of the upper and the lower portions 61 and 62 of the fixing base 6 are pivoted to each other; terminals of the upper and the lower portions 61 and 62 are opened up to place the handle bar 9 on the arc groove 621 disposed at the upper end of the lower portion 62 of the fixing base 6; the pivoting pin 623 is inserted into the through hole 6222 axially disposed in the insertion seat 622 of the lower portion 62 of the fixing base 6; the adjusting bolt 624 pivoted to the bottom in the pad holder 71 in inserted into the central through hole 6151 of the locating block 615, the central hole 6141 of the retainer 614, the central hole 6231 of the pivoting pin 623, and finally engaged to the adjusting nut 625. A summary operation is achieved by turning the pad holder 71 in conjunction with its eccentrically designed cylindrical inner side 711 to pull the adjusting bolt 624 and pressing the pad holder 71 in the direction of the handle bar 9, so that the circumference of the cylindrical inner side 711 of the pad holder 71 is restricted in the arc groove 6152 disposed on the top of the locating block 615 and both of the upper and the lower portions 61 and 62 of the fixing base 6 are packed into an integrated part with the handle bar 9 as illustrated in FIG. 8. On the contrary, to separate the entire pad holder and both of the upper and the lower portions 61 and 62 of the fixing base 6 from the handle bar 9, it takes only to directly pull up the entire pad holder 71 and turn for 90 degrees, and clear it away from those open troughs 616 and 6221 respectively disposed to the terminals of the locating seat 613 of the upper portion 61 and the insertion seat 62 of the lower portion 62 of the fixing base 6 with the pad holder 71 and the adjusting bolt 624 as the rotation center before pulling up and forward the upper portion 61 of the fixing base 6 to easily disengage the entire pad holder 71 and both of the upper and the lower portions 61 and 62 of the fixing base 6 from the handle bar 9 without depending on any hand tool.

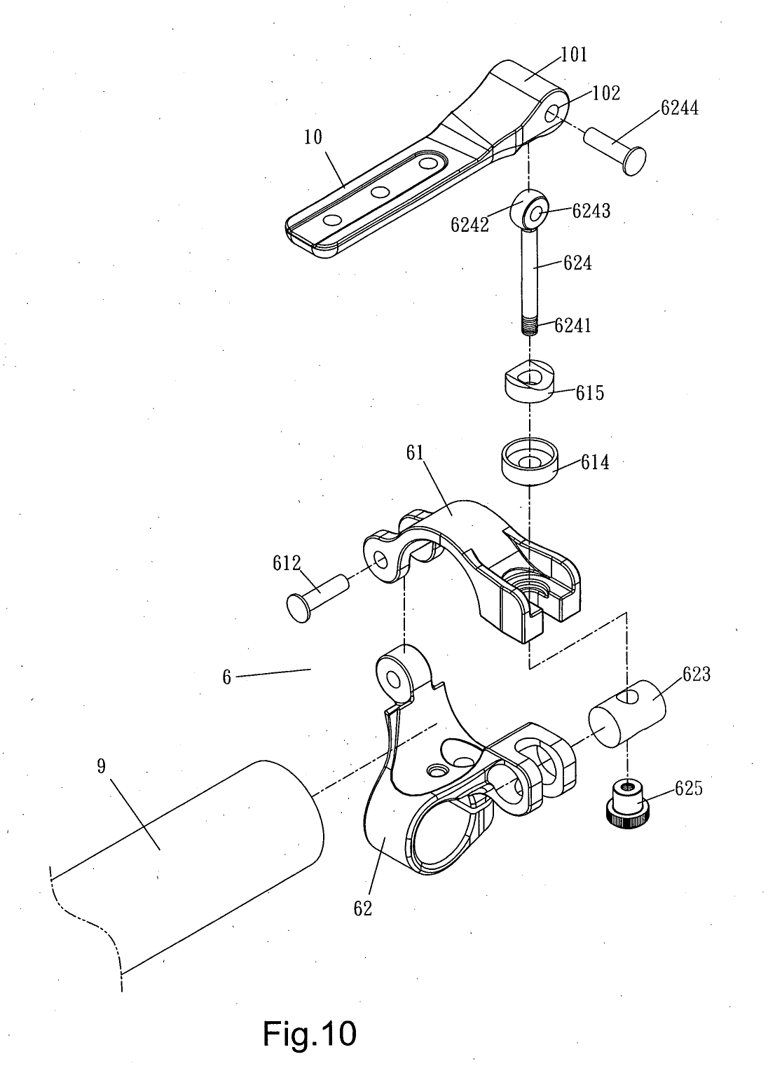

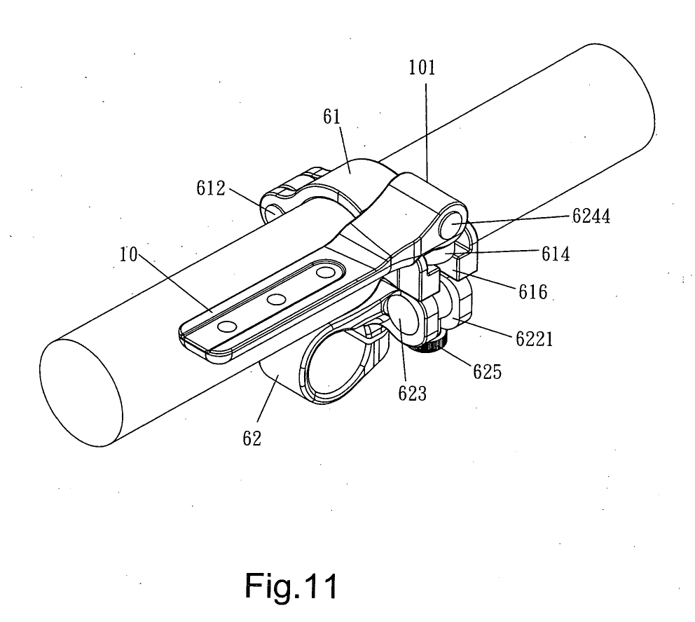

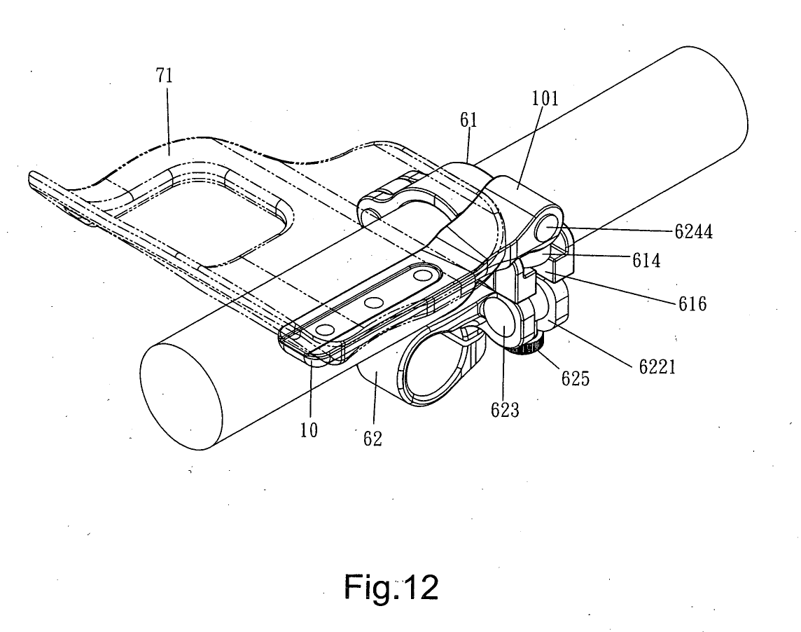

Furthermore, as illustrated in FIGS. 10-12, the pad holder 71 is connected to a linkage 10; an inner side 101 of the linkage 10 is designed in a cylindrical shape; an accommodation trough (not illustrated) is disposed at the bottom in the inner side 101, a biased hole 102 connecting through the accommodation trough is axially disposed in the linkage to have a top 6242 of the adjusting bolt 624 to be received in the accommodation trough disposed at the bottom in the inner side 101 for the adjusting bolt 624 to be pivoted to the linkage 10 by means of the pin 6244 to achieve the same purpose of having an easy separation of the pad holder 71 and both of the upper and the lower portions 61 and 62 of the fixing base 6 as an integrated part from the handle bar 9.

1-2. (canceled)

3. A fixing base for bike auxiliary handle bar comprising:
an upper portion having an upper end of the upper portion incorporated to a protection pad holder, and a lower portion having a lower end incorporated to the auxiliary handle bar;
a first arc groove being each disposed on a bottom of the upper portion and a second arc groove being disposed on a top of the lower portion, and the upper portion overlying the lower portion; an inner side of the pad holder being provided in a cylindrical shape;
a first accommodation trough being disposed on a bottom of the inner side of the pad holder, and a biased hole connecting through the first accommodation trough being axially provided in the cylindrical inner side;
a front of the upper portion and a front of the lower portion of the fixing base being both disposed with a pivoting hole, a pin being inserted through both pivoting holes to achieve movable pivoting between both of the upper and the lower portions of the fixing base;
a locating seat provided with a central locating hole being disposed at a terminal of the upper portion of the fixing base, a retainer located in the locating hole, the retainer being provided with a central through hole, a second accommodation trough being upwardly disposed in the retainer to receive insertion of a locating block, a center of the locating block having a through hole and a top of the locating block having a third arc groove, an open trough connecting through the locating hole being disposed to a terminal of the locating seat;
an insertion seat being disposed at a terminal of the lower portion of the fixing base, an open trough being disposed to a terminal of the insertion seat, and a through hole being axially disposed in the insertion seat to receive insertion of a pivoting pin provided with a central through hole to connect through the open trough;
an adjusting bolt having a threaded lower end being inserted into the central through hole of the locating block, the central through hole of the retainer, the central through hole of the pivoting pin, and engaged with an adjusting nut;
a trough hole being disposed at the top of the adjusting bolt with the top received in the first accommodation trough disposed at the bottom in the inner side of the pad hole; and
both of the adjusting bolt and the pad holder being pivoted into an integrated part by means of a pin,
wherein the pad holder is connected to a linkage, an inner side of the linkage being designed in a cylindrical shape a third accommodation trough being disposed at the bottom in the inner side, a biased hole connecting through the third accommodation trough being axially disposed in the linkage to have a top of the adjusting bolt received in the third accommodation trough disposed at the bottom in the inner side for the adjusting bolt to be pivoted to the linkage by means of the pin.
